(19) United States
(12) Patent Application Publication
(10) Pub. No.: US 2012/0068979 A1
(43) Pub. Date: Mar. 22, 2012

(54) E-book and power controller and power controlling method thereof

(75) Inventors: Kai-Cheng Chuang, Tainan City (TW); Tzu-Ming Wang, Kaohsiung County (TW)

(73) Assignee: E Ink Holdings Inc., Hsinchu (TW)

(21) Appl. No.: 12/926,299

(22) Filed: Nov. 9, 2010

(30) Foreign Application Priority Data
Sep. 16, 2010 (TW) 099131513

(51) Int. Cl. G09G 5/00

(52) U.S. Cl. 345/207; 345/212

(57) ABSTRACT

An e-book under an external light having an intensity is provided. The e-book includes a memory module storing data; an input/output interface electrically connected to the memory module, inputting the data to the memory module, and outputting the data from the memory module; an e-paper module electrically connected to the memory module, and displaying the data; a power device electrically connected to the e-paper module and the memory module, and providing a power output; and a photosensor electrically connected to the power device, having a threshold value, and sensing the intensity of the external light, wherein when the sensed intensity is lower than the threshold value, the power device reduces the power output.

### CROSS-REFERENCE TO RELATED APPLICATION AND CLAIM OF PRIORITY

This application claims the benefit of Taiwan Patent Application No. 099131513, filed on Sep. 16, 2010, in the Taiwan Patent and Trademark Office, the disclosures of which are incorporated herein in their entirety by reference.

### FIELD OF THE INVENTION

The present invention relates to a power controller and a power controlling method, and more particularly to a power controller and a power controlling method for an e-book.

### BACKGROUND OF THE INVENTION

Currently, the e-book is widely accepted as a kind of reading tool. However, in some situations, it is still inconvenient to use an e-book. For example, the user usually uses the e-book on the mass transit system or on his own car when waiting for the traffic sign. Nevertheless, when the user uses the e-book on the mass transit system, he is unable to read the e-book while entering, leaving or moving in the railway carriage. In this situation, the user usually will suspend using the e-book, and continue to read it after standing or sitting down stably. Under such circumstances, the e-book still consumes the power. This causes a waste of power. Similarly, the car driver also cannot use the e-book when he begins to drive after finishing waiting for the traffic sign. However, the e-book still consumes power at this time. This also causes a waste of power.

For solving such issue, some e-books have the standby function, which enables the user to actuate the standby function, usually by pressing the standby key, to achieve the object of saving power. However, this way not only wastes the time of the user since he has to press the standby key to actuate the standby function, but also may cause an accident since he might stray from pressing the standby key when entering, leaving or moving in the railway carriage.

Some e-books actuate the standby or turn-on function by triggering a microswitch. Usually, these e-books are equipped with an open-close cover, i.e. these e-books are disposed in the open-close cover. When the open-close cover is closed, the microswitch is triggered, thereby actuating the standby or turn-on function. However, the endurance of the microswitch is an issue. Since the microswitch is triggered through the transmission of mechanical force, the issues of mechanical friction and elasticity exhaustion will be generated. If the above-mentioned issue is to be overcome, the microswitch with high endurance has to be used. Nevertheless, this will greatly increase the production cost of the e-book since the microswitch with high endurance is very expensive. Another issue is the open-close cover itself. When these e-books are used, a dedicated open-close cover has to be used to trigger the microswitch effectively. If a non-dedicated open-close cover is used, the microswitch might not be triggered when the non-dedicated open-close cover is closed. Accordingly, the object of saving power cannot be achieved.

In order to overcome the drawbacks in the prior art, an e-book and the power controller and the power controlling method thereof are provided. The particular design in the present invention not only solves the problems described above, but also is easy to be implemented. Thus, the present invention has the utility for the industry.

### SUMMARY OF THE INVENTION

In accordance with an aspect of the present invention, an e-book and the power controller and the power controlling method thereof are provided. The e-book of the present invention can promptly actuate the standby or turn-on function in an easy way to achieve the effect of saving power.

In accordance with another aspect of the present invention, an e-book under an external light having an intensity is provided. The e-book includes a memory module storing data; an input/output interface electrically connected to the memory module, inputting the data to the memory module, and outputting the data from the memory module; an e-paper module electrically connected to the memory module, and displaying the data; a power device electrically connected to the e-paper module and the memory module, and providing a power output; and a photosensor electrically connected to the power device, having a threshold value, and sensing the intensity of the external light, wherein when the sensed intensity is lower than the threshold value, the power device reduces the power output.

Preferably, the photosensor is a photocell, and when the photocell is unable to be charged, the power device reduces the power output.

In accordance with a further aspect of the present invention, a power control method for an e-book having a power device is provided. The power control method includes steps of providing a photosensor having a threshold value; electrically connecting the photosensor to the power device; sensing an intensity of an external light by the photosensor; and reducing a power output of the power device when the sensed intensity is lower than the threshold value.

Preferably, the step of reducing the power output of the power device is performed by one of enabling the e-book to enter an energy-saving mode and turning off the power device.

Preferably, the photosensor is a photocell, and when the photocell is unable to be charged, the power device reduces the power output.

In accordance with further another aspect of the present invention, a power control method for an e-book having a power device is provided. The power control method includes steps of providing a gravity sensor to sense a gravity direction; electrically connecting the gravity sensor to the power device; and performing one of turning off a power output of the power device and enabling the e-book to enter an energy-saving mode when the gravity direction and a display direction of the e-book are pointed at a same direction.

In accordance with further another aspect of the present invention, a power control method for an e-book is provided. The power control method includes steps of providing a main controller; providing a gravity sensor sensing a gravity direction and electrically connected to the main controller; providing a photosensor sensing an external light having an intensity and electrically connected to the main controller; providing a power controller electrically connected to the main controller; receiving a power reducing signal from one of the gravity sensor and the photosensor by the main controller; and performing one of turning off a power output of the power controller and enabling the e-book to enter an energy-saving mode when the main controller receives the power reducing signal.

Preferably, the main controller receives the power reducing signal from the gravity sensor when the gravity direction and a display direction of the e-book are pointed at a same direction.

Preferably, the main controller receives the power reducing signal from the photosensor when the intensity of the external light is lower than a threshold value of the photosensor.

Preferably, the photosensor is a photocell, and when the photocell is unable to be charged, it sends the power reducing signal to the main controller.

In accordance with further another aspect of the present invention, a power controller for controlling a power output of an e-book under an external environment is provided. The power controller includes an environmental sensor sensing the external environment, wherein when the external environment is changed, the power controller reduces the power output of the e-book.

Preferably, the external environment includes an external light having an intensity, the environmental sensor has a threshold value, the environmental sensor senses the intensity of the external light, and when the intensity of the external light is lower than the threshold value, the power controller reduces the power output of the e-book.

Preferably, the external environment includes a gravity direction, the e-book has a display surface and a display direction outward and perpendicular to the display surface, the environmental sensor senses the gravity direction, and when the gravity direction and the display direction of the e-book are pointed at a same direction, the power controller reduces the power output of the e-book.

Preferably, the power controller further includes a main controller electrically connected to the environmental sensor, wherein the external environment includes a gravity direction and an external light having an intensity, and the environmental sensor senses the intensity of the external light and the gravity direction simultaneously, wherein the main controller uses one of the external light and the gravity direction as a main environmental parameter.

Preferably, the power controller reduces the power output of the e-book by performing one of enabling the e-book to enter an energy-saving mode and turning off the power output of the e-book.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows an e-book actuating the standby or turn-off function according to a preferred embodiment of the present invention;

FIG. 2 shows an e-book actuating the standby or turn-off function according to another preferred embodiment of the present invention;

FIGS. 3a and 3b show an e-book actuating the standby or turn-off function according to a further preferred embodiment of the present invention;

FIG. 4 shows an e-book actuating the standby or turn-off function according to further another preferred embodiment of the present invention; and

FIG. 5 is a circuit diagram of an e-book according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

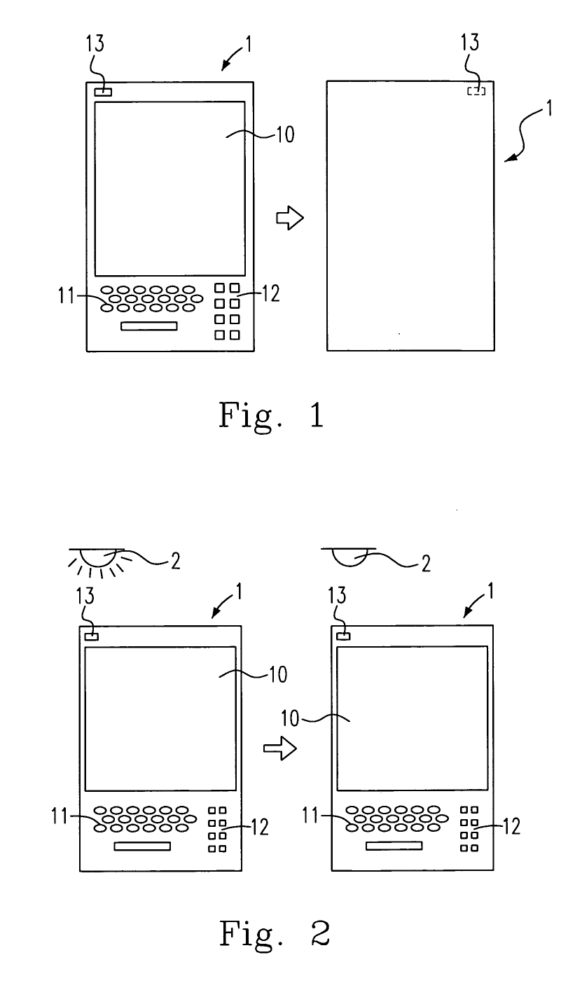

Please refer to FIG. 1, which shows an e-book actuating the standby or turn-off function according to a preferred embodiment of the present invention. The e-book 1 includes a display plane 10, a character key area 11 and a functional key area 12. The e-book 1 further includes a photosensor 13 for sensing the light. Generally, when the user uses the e-book 1, the display plane 10 faces the user, as shown in FIG. 1 at the left side. When the user puts the display plane 10 downward, the back of the e-book 1 faces upward and the photosensor 13 cannot sense the light, as shown in FIG. 1 at the right side. In general, when reading the e-book 1, the light always comes from the upper side of the e-book 1, i.e. the light always illuminates the display plane 10 at the front of the e-book 1. Therefore, once the back of the e-book 1 faces upward, it represents that the user does not use the e-book 1, and the light cannot illuminate the display plane 10 at the front of the e-book 1. Accordingly, the present invention actuates the standby or turn-off function in response to the change of light. Since the display plane 10 can only be illuminated by light when facing upward, the photosensor 13 is disposed at the front of the e-book 1, as shown in FIG. 1. When the user puts the e-book 1 on the table (not shown) or on the seat besides the cockpit (not shown) with its front facing downward, the photosensor 13 is not illuminated by light and will actuate the standby or turn-off function to achieve the effect of saving power.

Please refer to FIG. 2, which shows an e-book actuating the standby or turn-off function according to another preferred embodiment of the present invention. The e-book 1 includes a display plane 10, a character key area 11 and a functional key area 12. The e-book 1 further includes a photosensor 13 for sensing the light. Generally, when the user uses the e-book 1, the display plane 10 faces the user, as shown in FIG. 2 at the left side. Generally, when reading the e-book 1, the display plane 10 of the e-book 1 needs to be illuminated by light. Therefore, a light source 2 is usually disposed above the front of the e-book 1. Generally, the light source 2 is a lamp. When the user does not read the e-book 1, he usually will turn off the light source 2, as shown in FIG. 2 at the right side. At this time, the photosensor 13 does not sense light and will promptly actuate the standby or turn-off function to achieve the effect of saving power.

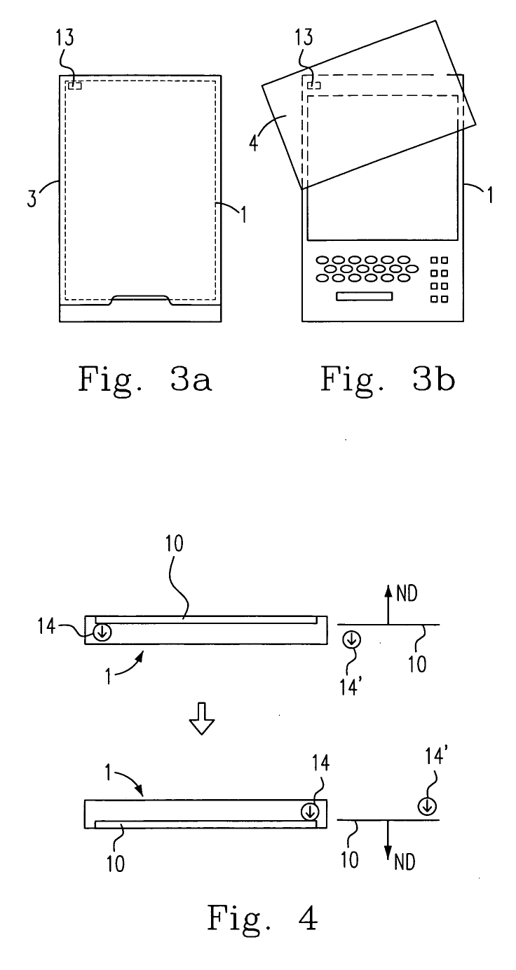

Please refer to FIGS. 3a and 3b, which show an e-book actuating the standby or turn-off function according to a further preferred embodiment of the present invention. FIG. 3a shows that the e-book 1 is placed in a container 3. Usually, the container 3 is a protecting sheath or a paper bag. When the e-book 1 is placed in the container 3, the photosensor 13 thereon does not sense light and will promptly actuate the standby or turn-off function to achieve the effect of saving power. FIG. 3b shows that when the user wants to actuate the standby or turn-off function, he can place a shelter 4 on the photosensor 13 so that the photosensor 13 does not sense light and will promptly actuate the standby or turn-off function to achieve the effect of saving power. Besides, the photosensor 13 can be replaced by a photocell. When the photocell is unable to be charged, it will actuate the standby or turn-off function.

Please refer to FIG. 4, which shows an e-book actuating the standby or turn-off function according to further another preferred embodiment of the present invention. The e-book 1 includes a display plane 10 and a gravity sensor 14. As shown in FIG. 4 at the upper side, when the e-book 1 is used, the display plane 10 faces upward, and the gravity direction 14′ is opposite to the normal direction ND of the display plane 10. At this time, the e-book 1 is in use and does not actuate the standby or turn-off function. In other words, when the included angle between the gravity direction 14′ and the normal direction ND is larger than 90 degrees, the e-book 1 is regarded as being in use. Moreover, as shown in FIG. 4 at the lower side, once the e-book 1 is not used and put on the table (not shown) or on the seat besides the cockpit (not shown) with the display plane 10 facing downward, the gravity direction 14′ is identical to or similar to the normal direction ND of the display plane 10. At this time, the e-book 1 is not in use and will actuate the standby or turn-off function. In other words, when the included angle between the gravity direction 14′ and the normal direction ND is smaller than 90 degrees, the e-book 1 is regarded as not being in use and will actuate the standby or turn-off function to achieve the effect of saving power.

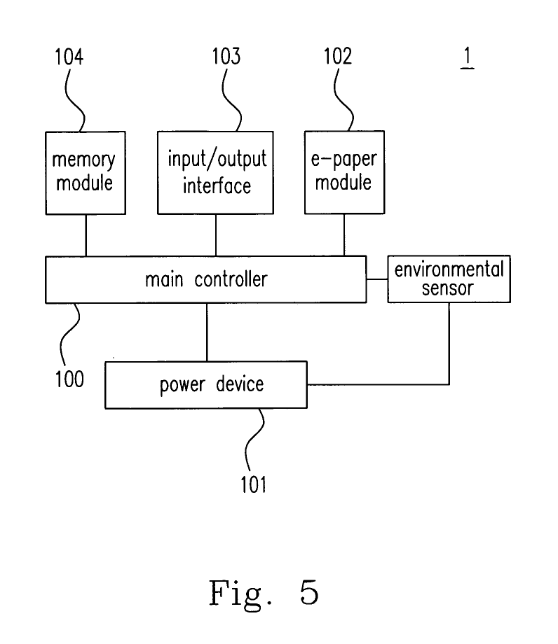

Please refer to FIG. 5, which is a circuit diagram of an e-book according to a preferred embodiment of the present invention. The e-book 1 includes a main controller 100, a memory module 104, an input/output interface 103, an e-paper module 102, a power device 101 and an environmental sensor 105. The main controller 100 is for controlling the e-book 1. The memory module 104 is electrically connected to the main controller 100 and for storing data. The input/output interface 103 is electrically connected to the main controller, and for inputting the data to the memory module 104 or outputting the data from the memory module 104. The e-paper module 102 is electrically connected to the main controller 100 and for displaying the data. The power device 101 is electrically connected to the main controller 100. Usually, the power device 101 is a power controller. The environmental sensor 105 is electrically connected to the main controller 100 and the power device 101. The environmental sensor 105 can be the photosensor 13 or the gravity sensor 14, or can include these two sensors 13, 14 simultaneously. Besides, the environmental sensor 105 can also be disposed in the power device 101 or the main controller 100. If the environmental sensor 105 is the photosensor 13, which has a threshold value and senses the intensity of the external light, when the sensed intensity is lower than the threshold value, the photosensor 13 informs the power device 101 to reduce the power output. Certainly, the photosensor 13 can also inform the power device 101 to reduce the power output via the main controller 100.

When the environmental sensor 105 includes the photosensor 13 and the gravity sensor 14, the priority of these two sensors 13, 14 is determined by the main controller 100. Generally, the photosensor 13 is set to the first priority. This is because when the e-book 1 is used on a vehicle, jolts will occur occasionally. At this time, the gravity direction 14′ of the gravity sensor 14 will point at the display plane 10 due to inertia. This will cause an erroneous determination and reduce the power output. If the e-book 1 is used in a static environment, the photosensor 13 and the gravity sensor 14 can be set to the same priority.

Based on the above-mentioned descriptions, the present invention also provides control methods for an e-book, especially power control methods for an e-book. Through the operation of the environmental sensor 105, e.g. whether the photosensor 13 senses light, or the gravity direction 14′ of the gravity sensor 14 is identical to or similar to the normal direction ND of the display plane 10 of the e-book 1, the power of the e-book 1 can be controlled. The detailed control methods have been described above, and will not be repeated here.

In conclusion, the present invention controls the power of the e-book via an environmental sensor to achieve the effect of saving power. By using the photosensor or the gravity sensor, the user can reduce the power output of the e-book by actuating the standby or turn-off function when he does not use the e-book, which is very convenient. For example, when the user turns off the desk lamp, puts the e-book into a protecting sheath or a paper bag, or covers the photosensor with a shelter, the power output of the e-book can be reduced. Hence, the present invention effectively solves the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An e-book under an external light having an intensity, comprising:
a memory module storing data;
an input/output interface electrically connected to the memory module, inputting the data to the memory module, and outputting the data from the memory module;
an e-paper module electrically connected to the memory module, and displaying the data;
a power device electrically connected to the e-paper module and the memory module, and providing a power output; and
a photosensor electrically connected to the power device, having a threshold value, and sensing the intensity of the external light, wherein when the sensed intensity is lower than the threshold value, the power device reduces the power output.

2. An e-book as claimed in claim 1, wherein the photosensor is a photocell, and when the photocell is unable to be charged, the power device reduces the power output.

3. A power control method for an e-book having a power device, comprising steps of
providing a photosensor having a threshold value;
electrically connecting the photosensor to the power device;
sensing an intensity of an external light by the photosensor; and
reducing a power output of the power device when the sensed intensity is lower than the threshold value.

4. A power control method as claimed in claim 3, wherein the step of reducing the power output of the power device is performed by one of enabling the e-book to enter an energy-saving mode and turning off the power device.

5. A power control method as claimed in claim 3, wherein the photosensor is a photocell, and when the photocell is unable to be charged, the power device reduces the power output.

6. A power control method for an e-book having a power device, comprising steps of:
providing a gravity sensor to sense a gravity direction;
electrically connecting the gravity sensor to the power device; and
performing one of turning off a power output of the power device and enabling the e-book to enter an energy-saving mode when the gravity direction and a display direction of the e-book are pointed at a same direction.

7. A power controller for controlling a power output of an e-book under an external environment, comprising:
an environmental sensor sensing the external environment, wherein when the external environment is changed, the power controller reduces the power output of the e-book.

8. A power controller as claimed in claim 7, wherein the external environment includes an external light having an intensity, the environmental sensor has a threshold value, the environmental sensor senses the intensity of the external light, and when the intensity of the external light is lower than the threshold value, the power controller reduces the power output of the e-book.

9. A power controller as claimed in claim 7, wherein the external environment includes a gravity direction, the e-book has a display surface and a display direction outward and perpendicular to the display surface, the environmental sensor senses the gravity direction, and when the gravity direction and the display direction of the e-book are pointed at a same direction, the power controller reduces the power output of the e-book.

10. A power controller as claimed in claim 7, further comprising a main controller electrically connected to the environmental sensor, wherein the external environment includes a gravity direction and an external light having an intensity, and the environmental sensor senses the intensity of the external light and the gravity direction simultaneously, wherein the main controller uses one of the external light and the gravity direction as a main environmental parameter.

11. A power controller as claimed in claim 7, wherein the power controller reduces the power output of the e-book by performing one of enabling the e-book to enter an energy-saving mode and turning off the power output of the e-book.
